(19) United States
(12) Patent Application Publication
(10) Pub. No.: US 2021/0146717 A1
(43) Pub. Date: May 20, 2021

(54) Dripless Paint Can

(71) Applicant: Fred Howard Barrows, IV, Middletown, RI (US)

(72) Inventor: Fred Howard Barrows, IV, Middletown, RI (US)

(21) Appl. No.: 17/098,356

(22) Filed: Nov. 14, 2020

Related U.S. Application Data
(60) Provisional application No. 62/974,162, filed on Nov. 18, 2019.

(51) Int. Cl. B44D 3/12

(52) U.S. Cl. CPC B44D 3/128; B44D 3/127

(57) ABSTRACT

A liquid-storing container is produced having holes punched during manufacturing into the plug type lid-receiving groove(s) of the container to mitigate the accumulation of excess liquids therein. During normal use, after initial opening of the container, liquids that would otherwise gather in said groove(s), either through pouring or the “brushing” of an applicator across the inner edge of the lid-receiving groove(s) to remove excess liquid, such as a paint brush, will now flow through said “pre-fab” holes and return to the interior of the container. In this invention, liquids that previously would overflow from the lid-receiving groove to the exterior wall of the container will be significantly limited, assuring minimal wasted liquids and a much cleaner exterior wall of the container and surrounding workspace. Additionally, after each use dried liquids cannot accumulate in the lid-receiving groove that would otherwise compromise the effectiveness of the reusable sealed lid of the container.

### CROSS-REFERENCE TO RELATED APPLICATIONS

Embodiments herein relate to liquid storing containers, and more particularly to controlling the spillage of excess liquid to the exterior of a liquid container and returning excess liquid captured in the plug type lid-receiving groove(s) of a container to the container.

### BACKGROUND

Many liquid storage containers, particularly for paint, are typically constructed having a lid-receiving groove or grooves located at an upper end of the can for accommodating a “plug type” lid. To secure the lid to the container, an annular protrusion of the lid can be aligned with the lid groove(s). The lid can then be pushed down such that the annular protrusion snugly engages with the groove(s), thus retaining the lid on the container and sealing the contents of the container such that they do not escape or dry up due to exposure to air.

In normal use, the lid is removed from the container and, particularly during painting, the user dips a brush or other applicator device into the container to collect the stored liquid on the applicator, then “brushes” the applicator against an inner lip of the container to remove excess liquid, particularly paint or paint-like substances, therefrom. Alternatively, the user can pour liquid from the container onto a receiving surface, or into another container such as a tray or smaller container.

During both operations, the stored liquid can collect in the lid-receiving groove(s) of the container. Such accumulation of liquid in the lid-receiving groove(s) is problematic, as the collected liquid can overflow the groove(s) to the exterior wall of the container, fouling said exterior wall as well as the surrounding workspace and/or immediate environment, and causing the unnecessary waste of the stored liquid. Further, excess liquid that gathers in the lid-receiving groove(s) can be expelled due to the pressure created when the plug type lid is forced back into the groove(s) during re-sealing. Additionally, if the excess liquid, particularly paint-like substances, is allowed to dry within the lid-receiving groove(s), it can interfere with the engagement between the lid and said groove(s), resulting in a poor seal after use or preventing the lid from engaging with the groove(s) altogether. Such a poor seal can permit dirt and air to contaminate the stored liquid and inter alia cause the degradation of the stored liquid.

A liquid-storing container is produced having one or more holes punched or otherwise fabricated during manufacturing through the lid-receiving groove(s) of the container to mitigate the accumulation of excess liquids therein. In this invention liquids that previously would overflow from the lid-receiving groove(s) to the exterior wall of the container will be significantly limited, assuring minimal wasted liquids and a much cleaner exterior wall and surrounding environment of the container. Additionally, after each use dried liquids cannot accumulate in the lid-receiving groove(s) that would otherwise compromise the effectiveness of the reusable sealed lid of the container.

Prior art solutions for protecting the lid-receiving groove(s) of a liquid container from the accumulation of excess liquid, particularly paint, and debris, includes the use of an annular groove protector that overlays the groove of the container to prevent liquid from entering into the groove(s). Some devices clip onto the inner and outer lips of the container to secure the device thereto and/or create a seal therewith. Other protectors incorporate a gasket in combination with an annular groove protector that seals against the inner lip of the container.

Existing devices for protecting the lid-receiving grooves of liquid storing containers, particularly paint cans, are problematic as they are purchased separately, not pre-fabricated intrinsically into the liquid container during manufacturing, are relatively complicated, comprising multiple components, must be replaced over time due to the accumulation of liquid thereon, thus interfering with proper fit with the container, and sometimes fail to adequately seal with the container lid, which allows liquid to bypass the protector and enter into the lid-receiving groove(s), subsequently spilling over the edge of the container to its exterior wall and potentially to the surrounding environment. Most groove protectors are also made of a substantially rigid material, such as hard plastics, for example, to clip onto the outer and/or inner lips of the liquid container, such as a paint can. Such rigid protectors are harder to store and ship. Existing groove protectors can also present edges or other structures that can catch on an applicator, such as a paintbrush, or other object, for example when a user is “brushing” excess paint off of a paintbrush onto the inner rim of a paint container and/or protector, potentially displacing the protector from engagement with the container. Moreover, such groove “protectors” can exacerbate the spillage of liquids to the exterior of the container or surrounding environment because they eliminate any “reservoir” altogether into which excess liquid can collect.

Liquid containers featuring one or more lid-receiving grooves are typically, but not always, produced in metal or plastic. If metal, the lid-receiving grooves are typically fabricated as a separate component/part machine-stamped to form groove(s) and inner and outer edges, which are then affixed to the tubular portion of the container by machine process. The most effective and efficient way to manufacture this invention is to modify the mold/die for the lid-receiving groove(s) component/part such that one or more through penetrations are “punched” through the groove(s) during the stamping process. This modification to a mold/die(s) is a minor, one-time and inexpensive redesign that requires no change or meaningful additional expense to the current manufacturing process.

### SUMMARY

Generally, one or more through penetrations are prefabricated in a lid-receiving groove(s) of a liquid storing container, such that accumulation of liquid, particularly paint, and debris therein is mitigated. For containers with shoulders adjacent to the groove, similar through penetrations can be prefabricated therein as well and further mitigate liquid, particularly paint, and debris from collecting on the shoulder of the groove of the container.

In a broad aspect, one or more through penetrations in the shoulder and lid-receiving grooves of a liquid storing container are fabricated during the production of the liquid storing container featuring such lid sealing grooves for mitigating accumulation of liquid, particularly paint, and debris therein, the liquid storing container having a tubular wall, a closed bottom, and an open top, the groove located between an inner lip and an outer lip of the top of the container and having a first wall depending from the inner lip, a second wall, and a groove width, and wherein a shoulder is located between a third wall depending from the outer lip and the second wall.

In an embodiment, four through penetrations are prefabricated into the grooves of a lid-receiving rim in quadrants typically but not necessarily equidistant around the circular rim of the liquid storing container.

### BRIEF DESCRIPTION OF THE DRAWINGS

FIG. 1 is a close-up cross-sectional elevation view of a lid-receiving groove 3 and shoulder 9 of a liquid storing container 1, particularly a paint can;

FIG. 2 is a close-up cross-sectional elevation view of a lid-receiving groove 3 and shoulder 9 of a liquid storing container 1, particularly a paint can, depicting a liquid 10 collecting in the lid-receiving groove 3 and shoulder 9;

FIG. 3 is a close-up cross-sectional elevation view of a lid-receiving groove 3 and shoulder 9 of a liquid storing container 1, particularly a paint can, depicting a liquid 10 collecting in the lid-receiving groove 3 and shoulder 9 overflowing that groove 3 and shoulder 9 and the outer edge 5 of the liquid container 1 and spilling over onto the outer surface 2 of the liquid container 1;

FIG. 4 is a close-up cross-sectional elevation view of a lid-receiving groove 3 and shoulder 9 of a liquid storing container 1, particularly a paint can, with prefabricated through holes 13 in the lid-receiving groove 3, depicting a liquid 10 that would otherwise collect in that groove 3 and shoulder 9 flowing through those holes 13 back into the liquid container 1, and no longer spilling over the outer edge 5;

FIG. 5 is a “Top View” of a liquid container 1 depicting prefabricated opposite “pole” through penetrations 13 of the lid-receiving groove 3.

FIG. 6 is a “3D” top and side view of a liquid container 1 depicting a liquid 11 that gathers in lid-receiving groove 3 and shoulder 9 flowing back into the liquid container 1 through opposite “pole” prefabricated penetrations 13 in the lid-receiving groove 3.

### DETAILED DESCRIPTION

According to embodiments herein, through hole penetrations 13 are fabricated through the lid-receiving grooves 3 of a liquid container 1, particularly a paint can, to mitigate the accumulation of excess liquid and other debris in the lid-receiving groove 3 and shoulder 9 of the liquid container 1.

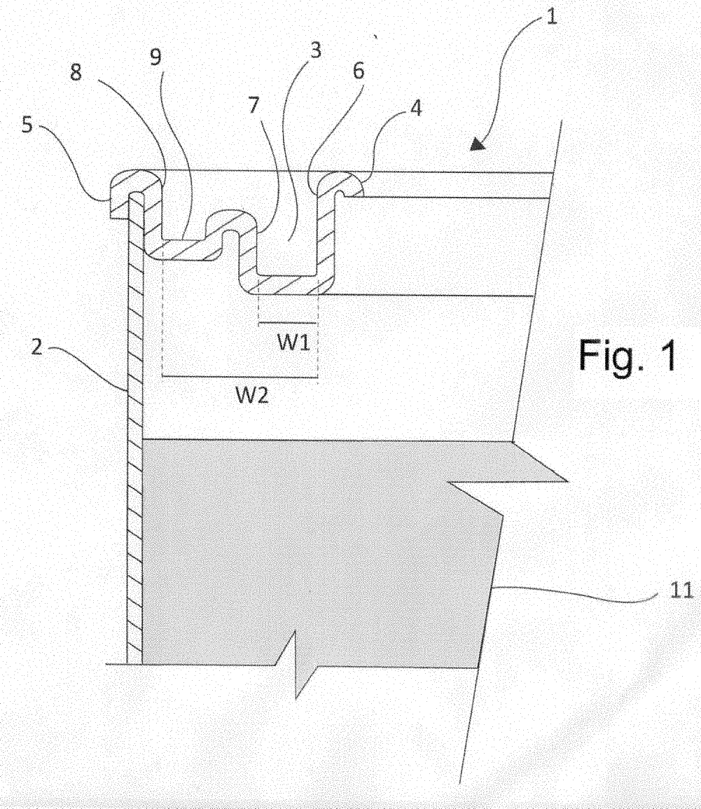

As shown in FIG. 1, a liquid container 1 of varying sizes, particularly a paint can, storing variable volumes of different liquids 11, typically comprises a tubular wall 2, a closed bottom, an open top, and a lid-receiving groove 3 located between an inner lip 4 and an outer lip 5 at the top of the liquid container 1. The groove 3 is defined by an inner first wall 6 depending from the inner lip 4, and a medial second wall 7 depending from a shoulder 9 and adjoining the first wall 6. Shoulder 9 is located between an outer third wall 8, depending from the outer lip 5, and the second wall 7 to accommodate a peripheral edge of the liquid container plug type lid (not shown). Dimensions “W1” and “W2” are variable, dependent largely on the overall size of the liquid container.

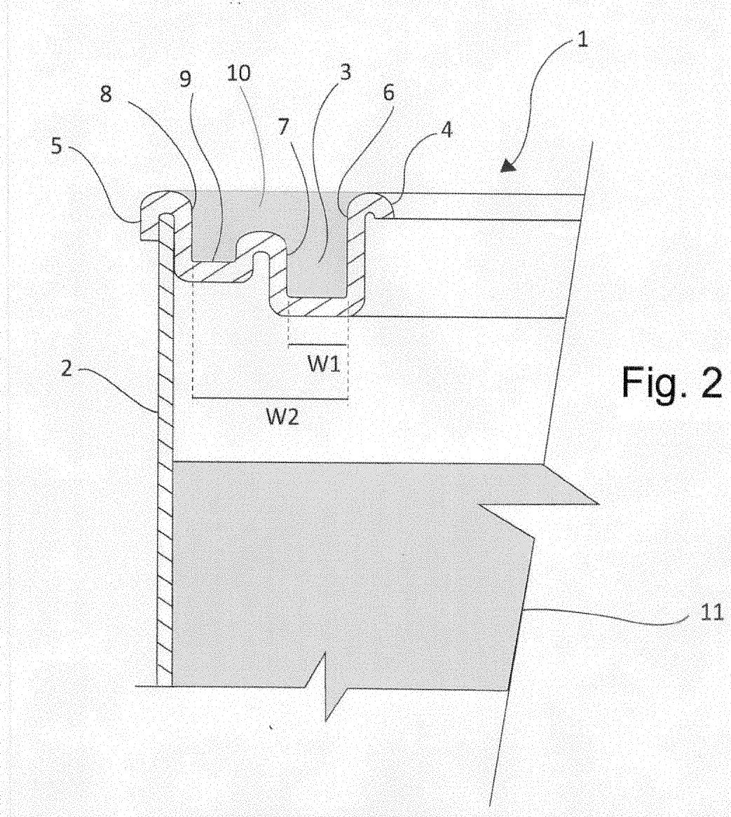

As shown in FIG. 2, once the lid (not shown) of the liquid container 1 is removed, through normal use of the liquid container 1, either through pouring of the stored liquid 11 or the “brushing” of an applicator/brush (not shown) against inner lip 4, excess liquid 10 collects in the groove 3 and shoulder 9.

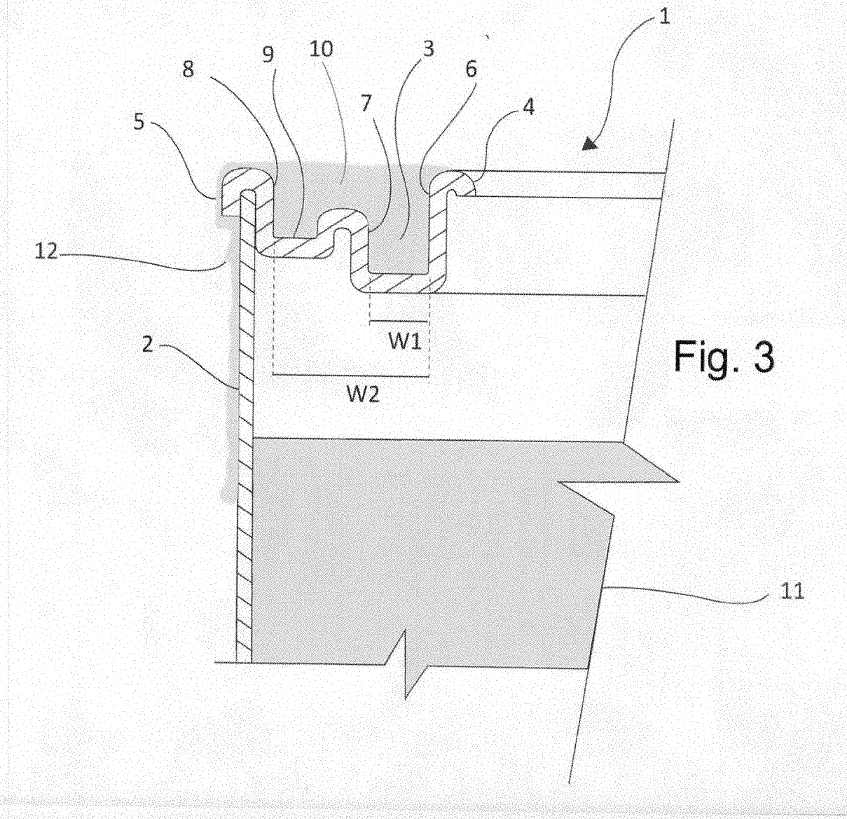

As shown in FIG. 3, the excess liquid 10 that collects in groove 3 and shoulder 9 typically overflows in normal use, spilling the liquid 10 over shoulder 9 and outer lip 5 onto the exterior of tubular wall 2 which, in normal usage, spreads the liquid 10 undesirably to the surrounding workplace and/or clothing and wastes the liquid 11 unnecessarily. If not otherwise prevented or removed, the excess liquid 10 that gathers in groove 3 and shoulder 9 can become dry and sticky prior to the resealing of the removable lid (not shown) into the groove 3 and shoulder 9, thus inhibiting the proper air tight seal necessary to preserve the quality of the stored liquid between uses.

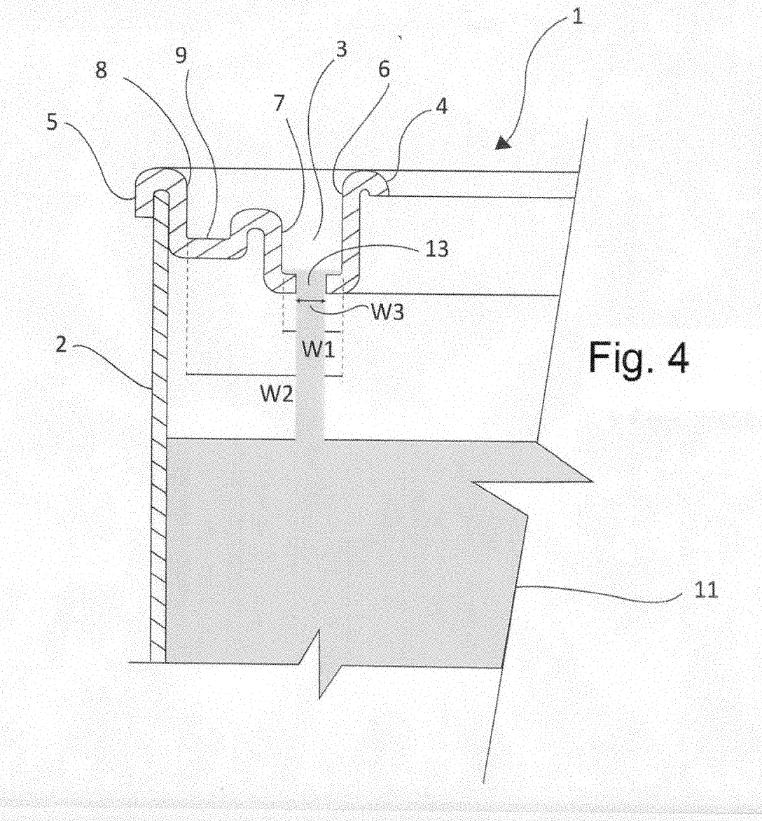

As shown in FIG. 4, the current invention embodies the pre-fabrication of one or more through holes 13 in groove 3, wherein any excess liquid 10 that would otherwise collect in groove 3 will return through holes 13 into the liquid container 1, thus minimizing undesirable spillage over shoulder 9 and outer lip 5 and the unnecessary waste of the stored liquid 11. Dimension “W3” of one or more of each through hole 13 is variable, dependent largely on the dimension of the groove 3 of the liquid container 1, which is largely dependent on the dimension of the liquid container 1 itself. By continuously removing the liquid 10 that would otherwise gather in the groove 3 and shoulder 9 and returning it into the liquid container 1, this assures a vastly improved airtight seal when the detachable lid (not shown) is reinserted into the groove 3 and shoulder 9, thus preserving the quality of the stored liquid 11.

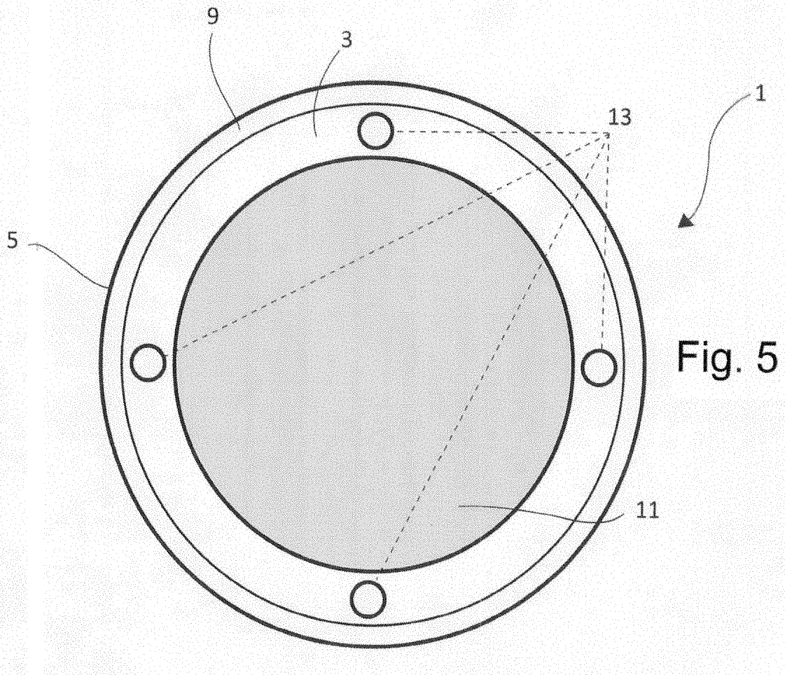

FIG. 5 is a “Top View” of a liquid container 1 with a lid-receiving groove 3 with adjoining shoulder 9 and outer rim 5, storing a liquid 11 and depicting four prefabricated through holes 13 in groove 3.

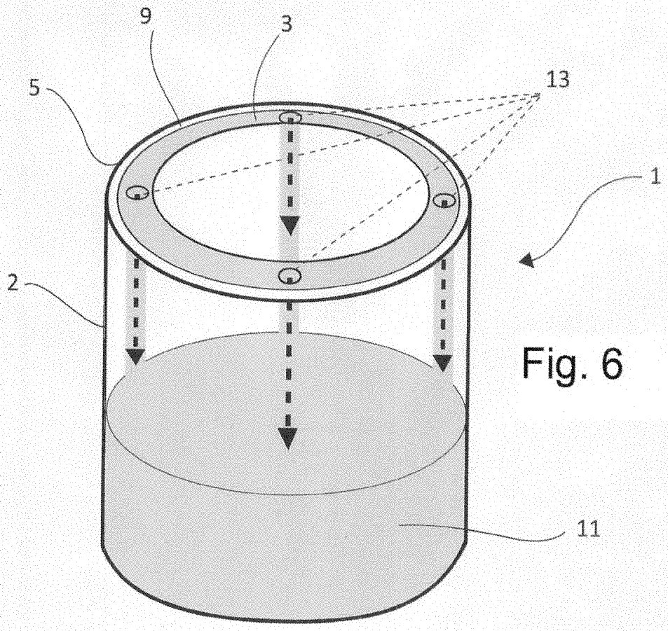

FIG. 6 is a “3D” side and top view of a liquid container 1 demonstrating liquid 11 that would otherwise collect during normal use in groove 3 and shoulder 9 returning to the interior of the liquid container 1 through one or more prefabricated penetration holes 13 in groove 3, thus significantly eliminating the undesirable spillage over the outer edge 5 to the exterior wall 2 of the liquid container 1, avoiding unnecessary waste of the stored liquid 11, and preserving the quality of the stored liquid 11.

We claim:

1. A liquid container of varying size, particularly a paint can, differentiated only by a plug type lid-receiving groove or grooves wherein one or more through hole penetrations are prefabricated into said groove or grooves to mitigate the accumulation of liquid in the lid-receiving groove or grooves of the liquid container, further comprised of a tubular wall, a closed bottom, and an open top, the groove typically located between an inner lip and an outer lip of the top of the liquid container and having a first wall depending from the inner lip, a second wall, and a groove width, and wherein a shoulder is located between a third wall depending from the outer lip and the second wall, the through hole penetrations having a dimension dependent on the dimensions of the lid-receiving groove or grooves and sufficient to allow the continuous flow of excess liquid that gathers in the groove or grooves back into the liquid container.

1. One or more through penetrations (“holes”) of varying dimensions prefabricated into the plug type lid-receiving groove(s) in the rim of a liquid-storing container to mitigate accumulation of excess liquid therein and the flow of said excess liquid to the exterior wall of the container and the surrounding workspace. Said liquid-storing container being fabricated from metal, plastic or other materials and being of various sizes, having a tubular wall, a closed bottom, and an open top, with one or more grooves located between an inner lip and an outer lip of the top of the container to receive the corresponding shape of a plug type lid to create a tight seal in order to contain and protect the liquid contents of the container.
